(19) United States
(12) Patent Application Publication
(10) Pub. No.: US 2025/0379236 A1
(43) Pub. Date: Dec. 11, 2025

(54) COLUMNAR SECONDARY BATTERY AND ELECTRONIC DEVICE

(71) Applicant: Xiamen Ampace Technology Limited, Xiamen (CN)

(72) Inventors: Chunhua LI, Xiamen (CN); Liwei ZHANG, Xiamen (CN); Yuecheng PENG, Xiamen (CN)

(73) Assignee: Xiamen Ampace Technology Limited, Xiamen (CN)

(21) Appl. No.: 19/230,587

(22) Filed: Jun. 6, 2025

(30) Foreign Application Priority Data
Jun. 6, 2024 (CN) 202410732527.7

(51) Int. Cl. H01M 4/75; H01M 4/02; H01M 10/0525; H01M 10/0587

(52) U.S. Cl. CPC H01M 4/75; H01M 10/0587; H01M 2004/027; H01M 10/0525

(57) ABSTRACT

A columnar secondary battery includes an electrode plate. The electrode plate includes a current collector and a material layer located on at least one surface of the current collector. Along a width direction of the electrode plate unwound, the current collector includes a coating region coated with the material layer, and a blank foil region. At least a part of the blank foil region forms a flattened portion. The blank foil region is provided with a plurality of first stripes. The plurality of first stripes extend along the width direction and are spaced apart from each other along a length direction of the electrode plate unwound. A mass of the blank foil region is M₀ g, a mass of a portion of the current collector equivalent to the plurality of first stripes in volume is M₁ g, and V=M₁/(M₀+M₁).

### CROSS-REFERENCE TO RELATED APPLICATIONS

This application claims the priority of Chinese Application No. 202410732527.7, filed on Jun. 6, 2024, the contents of which is incorporated herein by reference in its entirety.

### TECHNICAL FIELD

This application relates to the field of electrochemical technology, and in particular, to a columnar secondary battery and an electronic device.

### BACKGROUND

Columnar secondary batteries, such as a columnar lithium-ion battery, are applied to a plurality of high-rate discharge systems (in which the discharge rate is greater than 3 C, for example), and are widely used in the field of consumer electronics by virtue of a high specific energy, a high working voltage, a low self-discharge rate, a small size, a light weight, and other characteristics.

Currently, the design of high-power columnar lithium-ion batteries is typically a full-tab design, in which a positive tab and a negative tab extend from opposite directions and are prepared using a full-tab flattening technology. However, the full-tab flattening structure makes the electrode plate hardly wettable, especially at the middle part of the electrode plate, thereby giving rise to lithium plating at the beginning of or a late stage of cycling, and resulting in performance degradation of the lithium-ion battery.

### SUMMARY

An objective of this application is to provide a columnar secondary battery and an electronic device to improve the cycle performance of the secondary battery.

It is hereby noted that in the subject matter hereof, this application is construed by using a lithium-ion battery as an example of the columnar secondary battery, but the columnar secondary battery of this application is not limited to the lithium-ion battery. Specific technical solutions are as follows:

A first aspect of this application provides a columnar secondary battery. The columnar secondary battery includes an electrode plate. The electrode plate includes a current collector and a material layer located on at least one surface of the current collector. Along a width direction of the electrode plate unwound, the current collector includes a coating region coated with the material layer, and a blank foil region. At least a part of the blank foil region forms a flattened portion. The blank foil region is provided with a plurality of first stripes. The plurality of first stripes extend along the width direction and are spaced apart from each other along a length direction of the electrode plate unwound. A mass of the blank foil region is M₀ g, a mass of a portion of the current collector equivalent to the plurality of first stripes in volume is M₁ g, and V=M₁/(M₀+M₁). The material layer is provided with a plurality of second stripes. The plurality of second stripes extend along the width direction and are spaced apart from each other along the length direction. A mass of the material layer is M₀′ g, a mass of a portion of the material layer equivalent to the plurality of second stripes in volume is M₁′ g, and V′=M₁′/(M₀′+M₁′), satisfying: 0.1 V′≤V≤0.45, and optionally 0.1 V′≤V≤0.36; and 0.0001≤ V′≤0.35, and optionally 0.002≤V′≤0.27. By disposing the first stripes in the blank foil region and disposing the second stripes in the material layer, this application enables an electrolyte solution to diffuse rapidly on the electrode plate through the first stripes and the second stripes, thereby improving the circulation of the electrolyte solution on the electrode plate and effectively improving the infiltration effect of the electrolyte solution on the electrode plate, especially on the middle part of the electrode plate. The first stripes are disposed in coordination with the second stripes. The first stripes and the second stripes interact synergistically, thereby effectively improving the infiltration efficiency and infiltration performance of the electrolyte solution on the electrode plate, improving the infiltration effect of the electrolyte solution on the electrode plate, and in turn, improving the cycle performance of the columnar secondary battery.

In one or more embodiments, along the width direction of the electrode plate unwound, at least one of the plurality of first stripes extends through an end surface of the blank foil region at one end of the blank foil region facing away from the material layer; and/or, along the width direction of the electrode plate unwound, at least one of the plurality of second stripes extends through at least one end surface of the material layer. Along the width direction of the electrode plate unwound, the arrangement of the first stripes and the second stripes makes it convenient to introduce the electrolyte solution into the electrode plate, thereby improving the cycle performance of the secondary battery.

In one or more embodiments, along a thickness direction of the electrode plate, a thickness of the current collector is T₀ μm, and a maximum depth of a single first stripe is T₁ μm, satisfying: 0.2≤T₁/T₀≤0.9, and optionally 0.4≤T₁/T₀≤0.7; and 4≤T₀≤25. By controlling the values of T₁/T₀ and T₀ to fall within the above ranges, this application reduces the risk that the blank foil region is struck through by the first stripes when the first stripes are disposed in the blank foil region, thereby improving the cycle performance of the secondary battery while keeping good mechanical safety performance of the secondary battery.

In one or more embodiments, along a thickness direction of the electrode plate, a thickness of the material layer is H₀ μm, and a maximum depth of a single second stripe is H₁ μm, satisfying: 0.1≤H₁/H₀≤0.5, and optionally 0.2≤H₁/H₀≤0.4; and 20≤H₀≤140. By controlling the values of H₁/H₀ and H₀ to fall within the above ranges, this application reduces the risk that the material layer is struck through by the second stripes when the second stripes are disposed at the material layer, thereby improving the cycle performance of the secondary battery while keeping good mechanical safety performance and energy density of the secondary battery.

In one or more embodiments, along the length direction of the electrode plate unwound, a distance between two adjacent first stripes is A mm, satisfying: 1≤A≤10, and optionally 3≤A≤7. By adjusting the value of A to fall within the above range, the distance between two adjacent first stripes is made moderate, thereby improving the cycle performance of the secondary battery.

In one or more embodiments, along the length direction of the electrode plate unwound, a distance between two adjacent second stripes is A′ mm, satisfying: 0.5≤A′≤8, and optionally 3≤A′≤7. By adjusting the value of A′ to fall within the above range, the distance between two adjacent second stripes is made moderate, thereby improving the cycle performance of the secondary battery.

In one or more embodiments, along the width direction of the electrode plate unwound, based on a width of the blank foil region, a length percentage of a single first stripe is W, satisfying: 10%≤W≤80%, and optionally 30%≤W≤60%. Along the length direction of the electrode plate unwound, a width of a single first stripe is L mm, satisfying: 0.2≤L≤1, and optionally 0.4≤L≤0.8. By controlling the values of W and L to fall within the above ranges, it is convenient to distribute the first stripes on the surface of the electrode plate uniformly, thereby improving the cycle performance of the secondary battery while keeping good mechanical safety performance of the secondary battery.

In one or more embodiments, along the width direction of the electrode plate unwound, based on a width of the material layer, a length percentage of a single second stripe is W′, satisfying: 10%≤W′≤80%, and optionally 30%≤W′≤60%. Along the length direction of the electrode plate unwound, a width of a single second stripe is L′ mm, satisfying: 0.1≤L′ ≤1, and optionally 0.2≤L′≤0.6. By controlling the values of W′ and L′ to fall within the above ranges, it is convenient to distribute the second stripes on the surface of the electrode plate uniformly, thereby improving the cycle performance of the secondary battery.

In one or more embodiments, the electrode plate is a negative electrode plate.

A second aspect of this application provides an electronic device. The electronic device includes the columnar secondary battery disclosed in any one of the preceding embodiments. The columnar secondary battery of this application exhibits good cycle performance. Therefore, the electronic device of this application possesses a relatively long service life.

Beneficial effects of some embodiments of this application are as follows:

In some embodiments of this application, by disposing the first stripes in the blank foil region and disposing the second stripes in the material layer, this application enables an electrolyte solution to diffuse rapidly on the electrode plate through a specified relationship between the first stripes and the second stripes, thereby improving the circulation of the electrolyte solution on the electrode plate and effectively improving the infiltration effect of the electrolyte solution on the electrode plate, especially on the middle part of the electrode plate. The first stripes are disposed in coordination with the second stripes. The first stripes and the second stripes interact synergistically, thereby effectively improving the infiltration efficiency and infiltration performance of the electrolyte solution on the electrode plate, improving the infiltration effect of the electrolyte solution on the electrode plate, and in turn, improving the cycle performance of the columnar secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a partial front view of an electrode plate according to an embodiment of this application;

FIG. 2 is a cross-sectional view of an electrode plate sectioned along a P-P direction shown in FIG. 1;

FIG. 3 is a cross-sectional view of an electrode plate sectioned along a Q-Q direction shown in FIG. 1; and

FIG. 4 is a schematic diagram of diffusion of an electrolyte solution on an electrode plate in an electrode plate wettability test according to this application.

### LIST OF REFERENCE NUMERALS

electrode plate 001; current collector 10; material layer 20; blank foil region 11; coating region 12; first stripe 111; second stripe 201.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

Along the width direction of the electrode plate unwound, an electrolyte solution in a columnar secondary battery infiltrates the interior of the electrode plate to an inferior effect. In addition, the larger the flattened portion of the blank foil region, the fewer the infiltrated channels. Moreover, the internal voids in the flattened portion are relatively small, in which the electrolyte solution can hardly be circulated, so that the columnar secondary battery is poorly infiltrated. Consequently, lithium plating occurs on an interface in the battery, and the cycle performance of the battery is deteriorated. In view of the above problem, this application provides a columnar secondary battery. The electrode plate of the columnar secondary battery is well infiltrated to a good effect, and the secondary battery exhibits good cycle performance.

It is hereby noted that in specific embodiments of this application, this application is construed by using a lithium-ion battery as an example of the columnar secondary battery, but the columnar secondary battery of this application is not limited to the lithium-ion battery. Specific technical solutions are as follows:

A first aspect of this application provides a columnar secondary battery. The columnar secondary battery includes an electrode plate. The electrode plate includes a current collector and a material layer located on at least one surface of the current collector. Along a width direction of the electrode plate unwound, the current collector includes a coating region coated with the material layer, and a blank foil region. At least a part of the blank foil region forms a flattened portion. The blank foil region is provided with a plurality of first stripes. The plurality of first stripes extend along the width direction and are spaced apart from each other along a length direction of the electrode plate unwound. A mass of the blank foil region is M₀ g, a mass of a portion of the current collector equivalent to the plurality of first stripes in volume is M₁ g, and V=M₁/(M₀+M₁). The material layer is provided with a plurality of second stripes. The plurality of second stripes extend along the width direction and are spaced apart from each other along the length direction. A mass of the material layer is M₀′ g, a mass of a portion of the material layer equivalent to the plurality of second stripes in volume is M₁′ g, and V′=M₁′/(M₀′+M₁′), satisfying: 0.1 V′≤V≤0.45, and optionally 0.1 V′≤V≤0.36; and 0.0001≤V′≤0.35, and optionally 0.002≤V′≤0.27. For example, the value of V′ may be 0.0001, 0.0003, 0.0005, 0.0008, 0.001, 0.002, 0.003, 0.004, 0.005, 0.008, 0.01, 0.013, 0.015, 0.018, 0.02, 0.03, 0.04, 0.05, 0.08, 0.1, 0.12, 0.14, 0.15, 0.16, 0.18, 0.2, 0.22, 0.25, 0.27, 0.28, 0.3, 0.32, 0.35, or a value falling within a range formed by any two thereof. When the value of V′ is 0.0001, 0.00001≤V≤0.45, and the value of V may be 0.00001, 0.00003, 0.00005, 0.00008, 0.0001, 0.002, 0.003, 0.004, 0.005, 0.008, 0.01, 0.03, 0.05, 0.08, 0.1, 0.12, 0.15, 0.18, 0.2, 0.22, 0.25, 0.28, 0.3, 0.3 3, 0.35, 0.36, 0.38, 0.4, 0.42, 0.45, or a value falling within a range formed by any two thereof. When the value of V′ is 0.002, 0.0002≤V≤0.45, and the value of V may be 0.0002, 0.0005, 0.0008, 0.001, 0.002, 0.004, 0.005, 0.008, 0.01, 0.03, 0.05, 0.08, 0.1, 0.12, 0.15, 0.18, 0.2, 0.22, 0.25, 0.28, 0.3, 0.32, 0.35, 0.38, 0.4, 0.42, 0.45, or a value falling within a range formed by any two thereof. When the value of V′ is 0.27, 0.027≤V≤0.45, and the value of V may be 0.027, 0.03, 0.05, 0.08, 0.1, 0.12, 0.15, 0.18, 0.2, 0.22, 0.25, 0.28, 0.3, 0.32, 0.3 5, 0.38, 0.4, 0.42, 0.45, or a value falling within a range formed by any two thereof. When the value of V′ is 0.35, 0.035≤V≤0.45, and the value of V may be 0.035, 0.05, 0.08, 0.1, 0.12, 0.15, 0.18, 0.2, 0.22, 0.25, 0.28, 0.3, 0.33, 0.35, 0.38, 0.4, 0.42, 0.45, or a value falling within a range formed by any two thereof.

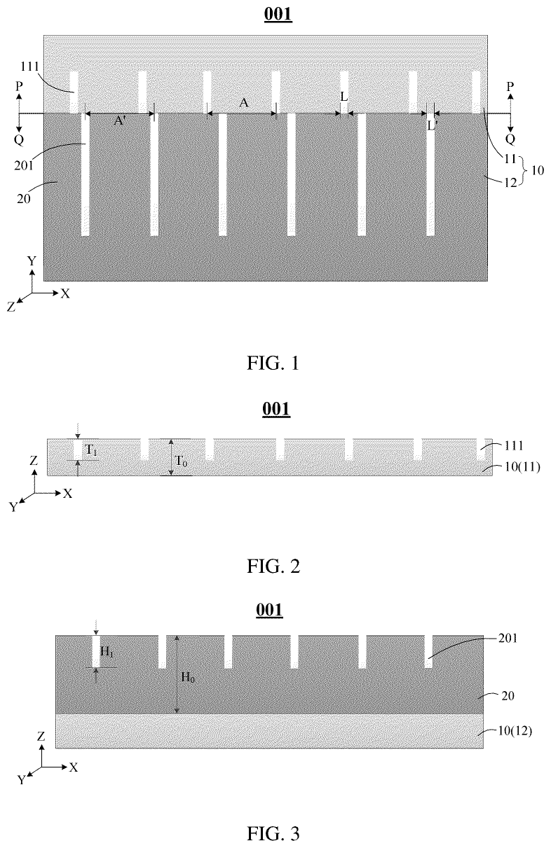

In this application, for ease of understanding, it is defined that, in an unwound state of the electrode plate, the length direction of the electrode plate is an X direction, the width direction of the electrode plate is a Y direction, and the thickness direction of the electrode plate is a Z direction. A three-dimensional coordinate system is established along the X direction, the Y direction, and the Z direction. As shown in FIG. 1 to FIG. 3, the electrode plate in FIG. 1 is sectioned along the P-P direction to obtain FIG. 2; and the electrode plate in FIG. 1 is sectioned along the Q-Q direction to obtain FIG. 3. The electrode plate 001 includes a current collector 10 and a material layer 20 located on one surface of the current collector 10. Along the width direction (Y direction) of the electrode plate 001 unwound, the current collector 10 includes a blank foil region 11 and a coating region 12 coated with the material layer 20. The blank foil region 11 is provided with first stripes 111. The first stripes 111 extend along the width direction (Y direction) of the electrode plate 001 unwound, and are spaced apart from each other along the length direction (X direction) of the electrode plate 001 unwound. The material layer 20 is provided with second stripes 201. The second stripes 201 extend along the width direction (Y direction) of the electrode plate 001 unwound, and are spaced apart from each other along the length direction (X direction) of the electrode plate 001 unwound.

When the values of V and V′ are excessively small, for example, less than a lower limit specified herein, the electrolyte solution infiltrates the electrode plate to an interior effect, thereby deteriorating the cycle performance of the secondary battery. When the value of Vis excessively large, for example, greater than an upper limit specified herein, the strength of the current collector is reduced, and the secondary battery fails to exhibit good cycle performance and good mechanical properties concurrently. When the value of V′ is excessively large, for example, greater than an upper limit specified herein, the content of the active material in the material layer is reduced excessively, thereby decreasing the energy density of the secondary battery, and increasing the risk of lithium plating at the beginning of and at a late stage of cycling of the secondary battery, and in turn, impairing the cycle performance of the secondary battery. The flattened portion in the blank foil region of the columnar secondary battery contains tortuous pore channels to be infiltrated, and is infiltrated by the electrolyte solution to an inferior effect. By disposing the first stripes in the blank foil region, this application provides more electrolyte guide channels for the flattened portion in the blank foil region, thereby improving the electrolyte infiltration effect in the blank foil region. The second stripes are disposed in the material layer. The first stripes coordinate with the second stripes. In this way, the electrolyte solution can be quickly diffused on the electrode plate, thereby improving the circulation of the electrolyte solution on the electrode plate, effectively improving the electrolyte infiltration effect on the electrode plate, especially on the middle part of the electrode plate. In addition, the values of V and V′ are controlled to fall within the above ranges, thereby reducing the risk that the mechanical safety performance of the secondary battery is impaired by the reduction of the hardness of the blank foil region during the preparation of the secondary battery. Moreover, the first stripes disposed in the blank foil region imposes little impact on the capacity of the secondary battery, and can effectively reduce the electrical internal resistance. With the first stripes disposed in coordination with the second stripes, the first stripes can interact synergistically with the second stripes to effectively improve the efficiency and performance of infiltration performed by the electrolyte solution on the layers of the electrode plate, thereby improving the consistency of internal resistance of the layers of the secondary battery, and improving the cycle performance of the columnar secondary battery.

Understandably, in this application, M₀+M₁ is a theoretical mass of the blank foil region before the first stripes are disposed, M₁ is the mass lost in the blank foil region due to the first stripes disposed, and M₀ is the actual mass after the first stripes are disposed in the blank foil region. M₀′+M₁′ is a theoretical mass of the material layer before the second stripes are disposed, M₁′ is the mass lost in the material layer due to the second stripes disposed, and M₀′ is the actual mass after the second stripes are disposed in the material layer.

In one or more embodiments, along the width direction of the electrode plate unwound, at least one of the plurality of first stripes extends through an end surface of the blank foil region at one end of the blank foil region facing away from the material layer; and/or, along the width direction of the electrode plate unwound, at least one of the second stripes extends through at least one end surface of the material layer. As shown in FIG. 1, along the width direction (Y direction) of the electrode plate 001 unwound, one of the plurality of first stripes 111 extends through an end surface of the blank foil region 11 at one end of the blank foil region facing away from the material layer 20; and, along the width direction (Y direction) of the electrode plate 001 unwound, a plurality of second stripes 201 extends through one end surface of the material layer 20. Along the width direction of the electrode plate unwound, the above arrangement of the first stripes and the second stripes makes it convenient to introduce the electrolyte solution into the interior of the electrode plate, and enables the electrolyte solution to diffuse rapidly on the electrode plate, thereby improving the circulation of the electrolyte solution on the electrode plate, effectively improving the infiltration effect of the electrolyte solution on the electrode plate, especially on the middle part of the electrode plate, and in turn, improving the cycle performance of the secondary battery.

In one or more embodiments, along the thickness direction of the electrode plate, the thickness of the current collector is T₀ μm, and the maximum depth of a single first stripe is T₁ μm. As shown in FIG. 2, along the thickness direction (Z direction) of the electrode plate 001, the thickness of the current collector 10 is T₀ μm, and the maximum depth of a single first stripe 111 is T₁ μm. The following relation is satisfied: 0.2≤T₁/T₀≤0.9, and optionally 0.4≤ T₁/T₀≤0.7. For example, the value of T₁/T₀ may be 0.2, 0.22, 0.25, 0.28, 0.3, 0.32, 0.35, 0.38, 0.4, 0.42, 0.45, 0.48, 0.5, 0.52, 0.55, 0.58, 0.6, 0.62, 0.65, 0.68, 0.7, 0.72, 0.75, 0.78, 0.8, 0.82, 0.85, 0.88, 0.9, or a value falling within a range formed by any two thereof. The following relation is satisfied: 4≤T₀≤25. For example, the value of T₀ may be 4, 5, 8, 10, 12, 15, 18, 20, 22, 25, or a value falling within a range formed by any two thereof. By controlling the values of T₁/T₀ and T₀ to fall within the above ranges, this application favorably improves the efficiency and performance of infiltration performed by the electrolyte solution on the electrode plate, improves the infiltration effect of the electrolyte solution on the electrode plate, and additionally, reduces the risk that the blank foil region is struck through by the first stripes when the first stripes are disposed in the blank foil region, thereby improving the cycle performance of the secondary battery while keeping good mechanical safety performance of the secondary battery. The method for controlling the thickness T₀ of the current collector is not particularly limited herein, as long as the objectives of this application can be achieved. For example, commercially available current collectors of different thicknesses may be selected, and the thicknesses of the current collectors may be determined with reference to the test method described in the section headed “Test of V, T₀, V′, and H₀” in this application, and then the current collector of the desired thickness is selected.

In one or more embodiments, along the thickness direction of the electrode plate, the thickness of the material layer is H₀ μm, and the maximum depth of a single second stripe is H₁ μm. As shown in FIG. 3, along the thickness direction (Z direction) of the electrode plate 001, the thickness of the material layer 20 is H₀ μm, and the maximum depth of a single second stripe 201 is H₁ μm. The following relation is satisfied: 0.1≤H₁/H₀≤0.5, and optionally, 0.2≤H₁/H₀≤0.4. For example, the value of H₁/H₀ may be 0.1, 0.12, 0.15, 0.18, 0.2, 0.22, 0.25, 0.28, 0.3, 0.32, 0.35, 0.38, 0.4, 0.42, 0.45, 0.48, 0.5, or a value falling within a range formed by any two thereof. The following relation is satisfied: 20≤H₀≤140. For example, the value of H₀ may be 20, 22, 25, 28, 30, 32, 35, 38, 40, 42, 45, 48, 50, 52, 55, 58, 60, 62, 65, 68, 70, 72, 75, 78, 80, 82, 85, 88, 90, 92, 95, 98, 100, 102, 105, 108, 110, 112, 115, 118, 120, 122, 125, 128, 130, 132, 135, 138, 140, or a value falling within a range formed by any two thereof. By controlling the values of H₁/H₀ and H₀ to fall within the above ranges, this application favorably improves the efficiency and performance of infiltration performed by the electrolyte solution on the electrode plate, improves the infiltration effect of the electrolyte solution on the electrode plate, and additionally, reduces the risk that the material layer is struck through by the second stripes when the second stripes are disposed in the material layer. In addition, the energy density of the secondary battery is made relatively high, thereby improving the cycle performance of the secondary battery while keeping good mechanical safety performance and energy density of the secondary battery. In this application, the thickness H₀ of the material layer may be controlled by means known to a person skilled in the art. For example, when a slurry is applied onto the surface of a current collector, on the basis that the solid content of the slurry is constant, the thickness H₀ of the material layer can be increased by increasing the coating weight; and the thickness H₀ of the material layer can be reduced by reducing the coating weight. Further, when the electrode is cold-pressed, the thickness H₀ of the material layer can be reduced by increasing the cold-pressing pressure, and the thickness H₀ of the material layer can be increased by reducing the cold-pressing pressure.

In one or more embodiments, along the length direction of the electrode plate unwound, the distance between two adjacent first stripes is A mm. As shown in FIG. 1, along the length direction (X direction) of the electrode plate 001 unwound, the distance between two adjacent first stripes 111 is A mm. The following relation is satisfied: 1≤A≤10, and optionally 3≤A≤7. For example, the value of A may be 1, 1.2, 1.5, 1.8, 2, 2.2, 2.5, 2.8, 3, 3.2, 3.5, 3.8, 4, 4.2, 4.5, 4.8, 5, 5.2, 5.5, 5.8, 6, 6.2, 6.5, 6.8, 7, 7.2, 7.5, 7.8, 8, 8.2, 8.5, 8.8, 9, 9.2, 9.5, 9.8, 10, or a value falling within a range formed by any two thereof. By controlling the value of A to fall within the above range, the distance between two adjacent first stripes is made moderate, this application reduces the risk of insufficient infiltration provided by the electrolyte solution for the electrode plate, and additionally, reduces the difficulty of processing and the risk of local collapse of the blank foil region during processing, improves the efficiency and performance of infiltration performed by the electrolyte solution on the electrode plate, and improves the infiltration effect of the electrolyte solution on the electrode plate, thereby improving the cycle performance of the secondary battery. In this application, the distance between two adjacent first stripes means a distance between width centers of the two adjacent first stripes along the length direction of the electrode plate unwound.

In one or more embodiments, along the length direction of the electrode plate unwound, the distance between two adjacent second stripes is A′ mm. As shown in FIG. 1, along the length direction (X direction) of the electrode plate 001 unwound, the distance between two adjacent second stripes 201 is A′ mm. The following relation is satisfied: 0.5≤A′ ≤8, and optionally 3≤A′≤7. For example, the value of A′ may be 0.5, 0.8, 1, 1.2, 1.5, 1.8, 2, 2.2, 2.5, 2.8, 3, 3.2, 3.5, 3.8, 4, 4.2, 4.5, 4.8, 5, 5.2, 5.5, 5.8, 6, 6.2, 6.5, 6.8, 7, 7.2, 7.5, 7.8, 8, or a value falling within a range formed by any two thereof. By controlling the value of A to fall within the above range, the distance between two adjacent second stripes is made moderate, this application reduces the risk of insufficient infiltration provided by the electrolyte solution for the electrode plate, and additionally, reduces the difficulty of processing and the risk of local collapse of the material layer during processing, improves the efficiency and performance of infiltration performed by the electrolyte solution on the electrode plate, and improves the infiltration effect of the electrolyte solution on the electrode plate, thereby improving the cycle performance of the secondary battery. In this application, the distance between two adjacent second stripes means a distance between width centers of the two adjacent second stripes along the length direction of the electrode plate unwound.

In one or more embodiments, along the width direction of the electrode plate unwound, based on the width of the blank foil region, the length percentage of a single first stripe is W, satisfying: 10%≤W≤80%, and optionally, 30%≤W≤60%. For example, the value of W may be 10%, 12%, 15%, 18%, 20%, 22%, 25%, 28%, 30%, 32%, 35%, 38%, 40%, 42%, 45%, 48%, 50%, 52%, 55%, 58%, 60%, 62%, 65%, 68%, 70%, 72%, 75%, 78%, 80%, or a value falling within a range formed by any two thereof. Along the length direction of the electrode plate unwound, the width of a single first stripe is L mm. As shown in FIG. 1, along the length direction (X direction) of the electrode plate 001 unwound, the width of a single first stripe 111 is L mm. The following relation is satisfied: 0.2≤L≤1, and optionally, 0.4≤L≤0.8. For example, the value of L may be 0.2, 0.22, 0.25, 0.28, 0.3, 0.32, 0.35, 0.38, 0.4, 0.42, 0.45, 0.48, 0.5, 0.52, 0.55, 0.58, 0.6, 0.62, 0.65, 0.68, 0.7, 0.72, 0.75, 0.78, 0.8, 0.82, 0.85, 0.88, 0.9, 0.92, 0.95, 0.98, 1, or a value falling within a range formed by any two thereof. By controlling the values of W and L to fall within the above ranges, this application makes it convenient to distribute the first stripes evenly on the surface of the electrode plate. The electrolyte solution flows on the electrode plate through the first stripes, thereby improving the infiltration effect of the electrolyte solution on the electrode plate, effectively improving the efficiency and performance of infiltration performed by the electrolyte solution on the electrode plate, and additionally, reducing the processing difficulty in an actual production process, and reducing the risk that the mechanical safety performance of the secondary battery is impaired by a decrease in hardness of the blank foil region during the preparation of the secondary battery, and in turn, improving the cycle performance of the secondary battery while achieving good mechanical safety performance of the secondary battery.

In one or more embodiments, along the width direction of the electrode plate unwound, based on the width of the material layer, the length percentage of a single second stripe is W′, satisfying: 10%≤W′≤80%, and optionally, 30%≤W′≤60%. For example, the value of W′ may be 10%, 12%, 15%, 18%, 20%, 22%, 25%, 28%, 30%, 32%, 35%, 38%, 40%, 42%, 45%, 48%, 50%, 52%, 55%, 58%, 60%, 62%, 65%, 68%, 70%, 72%, 75%, 78%, 80%, or a value falling within a range formed by any two thereof. Along the length direction of the electrode plate unwound, the width of a single second stripe is L′ mm. As shown in FIG. 1, along the length direction (X direction) of the electrode plate 001 unwound, the width of a single second stripe 201 is L′ mm. The following relation is satisfied: 0.1≤L′≤1, and optionally, 0.2≤L′≤0.6. For example, the value of L′ may be 0.1, 0.12, 0.15, 0.18, 0.2, 0.22, 0.25, 0.28, 0.3, 0.32, 0.35, 0.38, 0.4, 0.42, 0.45, 0.48, 0.5, 0.52, 0.55, 0.58, 0.6, 0.62, 0.65, 0.68, 0.7, 0.72, 0.75, 0.78, 0.8, 0.82, 0.85, 0.88, 0.9, 0.92, 0.95, 0.98, 1, or a value falling within a range formed by any two thereof. By controlling the values of W′ and L′ to fall within the above ranges, this application makes it convenient to distribute the second stripes evenly on the surface of the electrode plate. The electrolyte solution flows on the electrode plate through the second stripes, thereby improving the infiltration effect of the electrolyte solution on the electrode plate, effectively improving the efficiency and performance of infiltration performed by the electrolyte solution on the electrode plate, and additionally, reducing the processing difficulty in an actual production process, and reducing the risk that lithium plating occurs in the secondary battery caused by an excessive loss of the content of the active material in the material layer, and in turn, improving the cycle performance of the secondary battery.

In one or more embodiments, the electrode plate is a negative electrode plate. By disposing the first stripes and the second stripes on the blank foil region and the material layer of the negative electrode plate, this application further improves the efficiency and performance of infiltration performed by the electrolyte solution on the negative electrode plate, especially on the middle part of the negative electrode plate, and improves the infiltration effect of the electrolyte solution on the negative electrode plate more effectively, thereby further improving the cycle performance of the secondary battery.

In one or more embodiments, the electrode plate is a positive electrode plate. In one or more embodiments, the electrode plate is a positive electrode plate or a negative electrode plate. The above arrangement improves the efficiency and performance of infiltration performed by the electrolyte solution on the electrode plate, especially on the middle part of the electrode plate, and improves the infiltration effect of the electrolyte solution on the electrode plate, thereby improving the cycle performance of the secondary battery.

In this application, the cross-section of a single first stripe or the cross-section of a single second stripe means a plane formed by sectioning the first stripe or the second stripe along the length direction of the electrode plate unwound and the thickness direction of the stripe (or a cross-section obtained by sectioning the first stripe or the second stripe along the length direction and thickness direction of the electrode plate unwound). The cross-sectional shapes of a single first stripe and a single second stripe are not particularly limited herein, as long as the objectives of this application can be achieved. For example, the cross-sections of the single first stripe and the single second stripe each may be at least one independently selected from a triangle, an arc shape (the area of the arc shape is smaller than the area of a semicircle with the same radius), a semicircle, a rectangle, a trapezoid, or a square.

In this application, when the electrode plate is a positive electrode plate, “the electrode plate includes a current collector and a material layer located on at least one surface of the current collector” means that the positive electrode plate includes a positive current collector and a positive electrode material layer located on at least one surface of the positive current collector. The “positive electrode material layer located on at least one surface of the positive current collector” means that the positive electrode material layer may be disposed on one surface of the positive current collector or on both surfaces of the positive current collector along the thickness direction of the current collector. It is hereby noted that the “surface” here means a coating region provided with a positive electrode material layer in the positive current collector. The positive current collector is not particularly limited herein, as long as the objectives of this application can be achieved. For example, the positive current collector may include aluminum foil, aluminum alloy foil, a composite current collector (such as an aluminum carbon composite current collector), or the like. The positive electrode material layer of this application includes a positive active material. The type of the positive active material is not particularly limited herein, as long as the objectives of this application can be achieved. For example, the positive active material may include at least one of lithium nickel cobalt manganese oxide (LiNi_{0.90}Co_{0.05}Mn_{0.05}O₂ (NCM955), NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metal element. For example, the non-metal element includes at least one of fluorine, phosphorus, boron, chlorine, silicon, or sulfur. In this application, the positive electrode material layer may further include a positive electrode binder and a conductive agent. The type of the positive electrode binder in the positive electrode material layer is not particularly limited herein, as long as the objectives of this application can be achieved. For example, the positive electrode binder may include, but is not limited to, at least one of polyvinylidene fluoride, poly(vinylidene fluoride-co-hexafluoropropylene), polyamide, polyacrylonitrile, polyacrylate ester, polyacrylic acid, polyacrylate salt, polyvinylpyrrolidone, polyvinyl ether, polymethylmethacrylate, polytetrafluoroethylene, or polyhexafluoropropylene. The type of the conductive agent in the positive electrode material layer is not particularly limited herein, as long as the objectives of this application can be achieved. For example, the conductive agent may include, but is not limited to, at least one of conductive carbon black (Super P), carbon nanotubes (CNTs), carbon fibers, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. The mass ratio between the positive active material, the conductive agent, and the positive electrode binder in the positive electrode material layer is not particularly limited herein, and may be selected by a person skilled in the art as actually required, as long as the objectives of this application can be achieved.

In this application, when the electrode plate is a negative electrode plate, “the electrode plate includes a current collector and a material layer located on at least one surface of the current collector” means that the negative electrode plate includes a negative current collector and a negative electrode material layer located on at least one surface of the negative current collector. The “negative electrode material layer located on at least one surface of the negative current collector” means that the negative electrode material layer may be disposed on one surface of the negative current collector or on both surfaces of the negative current collector along the thickness direction of the current collector. It is hereby noted that the “surface” here means a coating region provided with a negative electrode material layer in the negative current collector. The negative current collector is not particularly limited herein, as long as the objectives of this application can be achieved. For example, the negative current collector may be copper foil, copper alloy foil, nickel foil, stainless steel foil, titanium foil, foamed nickel, foamed copper, a composite current collector (such as a lithium-copper composite current collector, a carbon-copper composite current collector, a nickel-copper composite current collector, or a titanium-copper composite current collector), or the like. The negative electrode material layer in this application includes a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ (0<x<2), Li—Sn alloy, Li—Sn—O alloy, Sn, SnO, SnO₂, spinel-structured lithium titanium oxide Li₄Ti₅O₁₂, Li—Al alloy, or metallic lithium. Optionally, the negative electrode material layer may further include a conductive agent and a negative electrode binder. The type of the conductive agent in the negative electrode material layer is not particularly limited herein, as long as the objectives of this application can be achieved. For example, the type of the conductive agent may be the same as the conductive agent in the positive electrode material layer described above. The type of the negative electrode binder in the negative electrode material layer is not particularly limited herein, as long as the objectives of this application can be achieved. For example, the type of the negative electrode binder may be the same as the positive electrode binder in the positive electrode material layer described above. The mass ratio between the negative active material, the conductive agent, and the negative electrode binder in the negative electrode material layer is not particularly limited herein as long as the objectives of this application can be achieved.

The method for preparing the electrode plate is not particularly limited herein, as long as the objectives of this application can be achieved. For example, a preparation method of the electrode plate includes, but is not limited to, the following steps: (1) formulating a slurry; (2) applying the slurry onto one surface of the current collector, and oven-drying the current collector to obtain an electrode plate provided with a material layer on a single side; (3) applying the slurry onto the other surface of the current collector, and oven-drying the current collector to obtain an electrode plate provided with a material layer on both sides; (4) cold-pressing and slitting the electrode plate, and then, along the width direction of the electrode plate unwound, determining a coating region provided with the material layer and a blank foil region on the current collector, disposing first stripes in the blank foil region, and disposing second stripes in the material layer, thereby obtaining an electrode plate. When the slurry is applied onto one surface of the current collector, that is, when only one side of the current collector is provided with the material layer in the coating region of the current collector, both the first stripes and the second stripes are disposed on the same surface of the electrode plate. When the slurry is applied onto both surfaces of the current collector, that is, when both sides of the current collector are provided with the material layer in the coating region of the current collector, the first stripes may be disposed on any surface of the electrode plate, and the second stripes may be disposed only on the surface, provided with the first stripes, of the electrode plate, or, the second stripes may be disposed on both surfaces of the electrode plate.

The solid content of the slurry is not particularly limited herein, as long as the objectives of this application can be achieved. The oven-drying temperature and time are not particularly limited herein, as long as the objectives of this application can be achieved. The process parameters for the cold-pressing and slitting are not particularly limited herein, as long as the objectives of this application can be achieved. The methods for disposing the first stripes and the second stripes are not particularly limited herein, as long as the objectives of this application can be achieved. For example, the first stripes and the second stripes may be disposed by pulsed laser etching. The maximum depth T₁ of a single first stripe, the maximum depth H₁ of a single second stripe, the width L of a single first stripe, and the width L′ of a single second stripe may be regulated by using the power and the defocus amount of a pulsed laser emitter. The length percentage W % of a single first stripe may be regulated by adjusting the width of the blank foil region as well as the power and the defocus amount of the pulsed laser emitter. The length percentage W′% of a single second stripe may be regulated by adjusting the width of the material layer as well as the power and the defocus amount of the pulsed laser emitter. The distance A between two adjacent first stripes and the distance A′ between two adjacent second stripes may be regulated by adjusting the distance between the pulsed laser emitters or the laser emission frequency. The value of V may be regulated by adjusting the size of the blank foil region, the power of the pulsed laser emitter, the defocus amount, the distance between the pulsed laser emitters, the laser emission frequency, or the like. The value of V′ may be regulated by adjusting the size of the material layer, the power of the pulsed laser emitter, the defocus amount, the distance between the pulsed laser emitters, the laser emission frequency, or the like.

In this application, a person skilled in the art understands that when the first stripes and the second stripes are disposed by pulsed laser etching, the mass M₁ of a portion of the current collector equivalent to the plurality of first stripes in volume is an etching amount of the blank foil region, and the mass M₁′ of a portion of the material layer equivalent to the plurality of second stripes in volume is an etching amount of the material layer.

The columnar secondary battery in this application includes an electrolyte solution. The electrolyte solution includes a lithium salt and a nonaqueous solvent. The lithium salt may include at least one of LiPF₆, LiNO₃, LiBF₄, LiClO₄, LiB(C₆H₅)+, LiCH₃SO₃, LiCF₃SO₃, LiN(SO₂CF₃)₂, LiC(SO₂CF₃)₃, Li₂SiF₆, lithium bis(oxalato) borate (LiBOB), lithium bis(trifluoromethanesulfonyl)imide (LiTFSI), or lithium difluoroborate. The content of the lithium salt in the electrolyte solution is not particularly limited herein, as long as the objectives of this application can be achieved. The nonaqueous solvent is not particularly limited herein, as long as the objectives of this application can be achieved. For example, the nonaqueous solvent includes, but is not limited to, at least one of a carbonate ester compound, a carboxylate ester compound, an ether compound, or other organic solvents. The carbonate ester compound may include, but is not limited to, at least one of a chain carbonate ester compound, a cyclic carbonate ester compound, or a fluorocarbonate ester compound. The chain carbonate ester compound may include, but is not limited to, at least one of dimethyl carbonate, diethyl carbonate, dipropyl carbonate, methyl propyl carbonate, ethylene propyl carbonate, or ethyl methyl carbonate. The cyclic carbonate ester compound may include, but is not limited to, at least one of ethylene carbonate, propylene carbonate (PC), butylene carbonate, or vinyl ethylene carbonate. The fluorocarbonate ester compound may include, but is not limited to, at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate ester compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The separator is not particularly limited herein as long as the objectives of this application can be achieved. For example, the separator may be made of a material including, but not limited to, at least one of polyethylene (PE)-based, polypropylene (PP)-based polyolefin (PO) separator, polyester (such as polyethylene terephthalate (PET) film), cellulose, polyimide (PI), polyamide (PA), spandex, or aramid. The type of the separator may include a woven film, a nonwoven film, a microporous film, a composite film, a calendered film, or a spinning film. The separator of this application may assume a porous structure. The pore size of the porous structure of the separator is not particularly limited herein, as long as the objectives of this application can be achieved. For example, the pore size may be 0.01 μm to 1 μm. The thickness of the separator is not particularly limited herein, as long as the objectives of this application can be achieved. For example, the thickness of the separator may be 5 μm to 40 μm.

The columnar secondary battery of this application further includes a housing. The housing is configured to accommodate a positive electrode plate, a negative electrode plate, a separator, an electrolyte solution, and other components known in the art for use in a columnar secondary battery. Such other components are not limited herein. The housing is not particularly limited herein, and may be a housing well-known in the art, as long as the objectives of this application can be achieved.

The columnar secondary battery is not particularly limited herein, and may be any device in which an electrochemical reaction occurs. In an embodiment of this application, the columnar secondary battery may be, but is not limited to, a lithium-ion secondary battery (lithium-ion battery), a lithium polymer secondary battery, a lithium-ion polymer secondary battery, or the like.

The method for preparing the columnar secondary battery is not particularly limited herein, and may be any preparation method well-known in the art, as long as the objectives of this application can be achieved. For example, a method for preparing the columnar secondary battery includes, but is not limited to, the following steps: stacking the separator, the positive electrode plate, the separator, and the negative electrode plate in sequence, and performing operations such as winding and folding as required on the stacked structure to obtain a jelly-roll electrode assembly; putting the electrode assembly into a housing, injecting an electrolyte solution into the housing, and sealing the housing to obtain columnar a secondary battery.

A second aspect of this application provides an electronic device. The electronic device includes the columnar secondary battery disclosed in any one of the preceding embodiments. The columnar secondary battery of this application exhibits good cycle performance. Therefore, the electronic device of this application possesses a relatively long service life.

The electronic device is not particularly limited herein, and may be any electronic device known in the prior art. For example, the electronic device may include, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods. In addition, unless otherwise specified, the word “parts” means parts by mass, and the symbol “%” means a percentage by mass.

### Test Methods and Devices:

Test of V, T₀, V′, and H₀:

At an ambient temperature of 25° C., a lithium-ion battery is discharged at a current of 0.5 C until the voltage drops to 2.5 V, and then disassembled. An electrode plate provided with first stripes and second stripes is taken out and soaked in dimethyl carbonate (DMC) for 20 minutes. Subsequently, the electrode plate is placed in an oven and dried at 80° C. for 12 hours, thereby obtaining an electrode plate sample. Along the width direction of the electrode plate unwound, the blank foil region and the coating region of the current collector are distinguished by identifying a junction between the current collector and the material layer. A dividing line between the blank foil region and the coating region is determined. The current collector is cut along the dividing line between the blank foil region and the coating region, thereby obtaining the blank foil region and the coating region.

The blank foil region is weighed to obtain a mass M₀, that is, the actual mass of the blank foil region, denoted as M_{actual}. The blank foil region is fully unwound. The length and width of the blank foil region and the thickness T₀ of the current collector are measured separately. M₀+M₁ is equal to the length of the blank foil region×the width of the blank foil region×the thickness of the current collector T₀×the density of the current collector (foil), that is, the theoretical mass M_{theoretical} of the blank foil region without the first stripes. Therefore,

$${M}_{1} = {M}_{t h e o r etical} - {M}_{actual} , and V = {M}_{1} / ( {M}_{0} + {M}_{1} ) = ( {M}_{t h e o r e t ical} - {M}_{a c tual} ) / {M}_{t h e o r e t ical} .$$

The coating region is fully unwound, and the thickness H₀ of the material layer is measured along the thickness direction of the electrode plate. Along the length direction of the electrode plate unwound, a material layer with a length of L₁ is measured out, and is scraped off from the current collector by using a scraper, and is weighed to obtain a mass denoted as M_{L1}. Along the length direction of the electrode plate unwound, the total length of the material layer is measured as L₂. Therefore, M_{L1}×(L₂/L₁) is equal to M₀′+M₁′, that is, the theoretical mass M_{theoretical}′ of the material layer without the second stripes. The remaining material layer is scraped off from the current collector by using a scraper, and the material layer weighed out as M_{L1} is added, and the aggregate material layer is weighed together to obtain the mass M₀′ of the material layer, that is, the actual mass M_{actual}′ of the material layer. Therefore, M₁′=M_{theoretical}′−M_{actual}′, and V′=M₁′/(M₀′+M₁′)=(M_{theoretical}′−M_{actual}′)/M_{theoretical}′.

Test of T₁, H₁, L, L′, W, W′, A, and A′:

At an ambient temperature of 25° C., a lithium-ion battery is discharged at a current of 0.5 C until the voltage drops to 2.5 V, and then disassembled. An electrode plate provided with first stripes and second stripes is taken out and soaked in dimethyl carbonate (DMC) for 20 minutes. Subsequently, the electrode plate is placed in an oven and dried at 80° C. for 12 hours, thereby obtaining an electrode plate sample.

Along the width direction of the electrode plate unwound, the blank foil region and the coating region of the current collector are distinguished by identifying a junction between the current collector and the material layer. A dividing line between the blank foil region and the coating region is determined. Along the width direction of the electrode plate, the width of the blank foil region is measured. 5 first stripes are selected at random, and the lengths of the first stripes are measured. The average of the measured values is the length of a single first stripe. The length of a single first stripe is divided by the width of the blank foil region to obtain a length percentage W of a single first stripe based on the width of the blank foil region. Along the width direction of the electrode plate, the width of the material layer in the coating region is measured. 5 second stripes are selected at random. The lengths of the second stripes are measured, and the average of the measured values is the length of a single second stripe. The length of a single second stripe is divided by the width of the material layer to obtain a length percentage W′ of a single second stripe based on the width of the material layer.

The electrode plate is cut along the thickness direction of the electrode plate and a dividing line between the blank foil region and the coating region to obtain a longitudinal section of the blank foil region (that is, a section of the electrode plate along the P-P direction) and a longitudinal section of the coating region (that is, the section of the electrode plate along the Q-Q direction). The longitudinal section in each region is measured by using a scanning electron microscope.

The section of the electrode plate along the P-P direction is ion-polished to obtain a section of the blank foil region. The section of the blank foil region is observed using an electron scanning microscope. 5 first stripes are selected at random. The width of each single first stripe is measured along the length direction of the electrode plate unwound, and the average of the measured values is the width L of a single first stripe. The distance between the width center of each single first stripe and the width center of an adjacent first stripe is measured, and the average of the measured values is the distance A between two adjacent first stripes. Along the thickness direction of the electrode plate, the distance between the surface of the blank foil region and the deepest point of each single first stripe is measured, and the average of the measured values is the maximum depth T₁ of a single first stripe.

The section of the electrode plate along the Q-Q direction is ion-polished to obtain a section of the coating region. The section of the coating region is observed using an electron scanning microscope, and a dividing line between the material layer and the current collector is clearly visible. 5 second stripes are selected at random. The width of each single second stripe is measured along the length direction of the electrode plate unwound, and the average of the measured values is the width L′ of a single second stripe. The distance between the width center of each single second stripe and the width center of an adjacent second stripe is measured, and the average of the measured values is the distance A′ between two adjacent second stripes. Along the thickness direction of the electrode plate, the distance between the surface of the material layer and the deepest point of each single second stripe is measured, and the average of the measured values is the maximum depth H1 of a single second stripe.

### Electrode Plate Infiltration Test:

The infiltration effect of the electrolyte solution for the negative electrode plate is characterized by a diffusion distance of the electrolyte solution on the surface of the negative electrode plate. Specific operation steps are as follows:

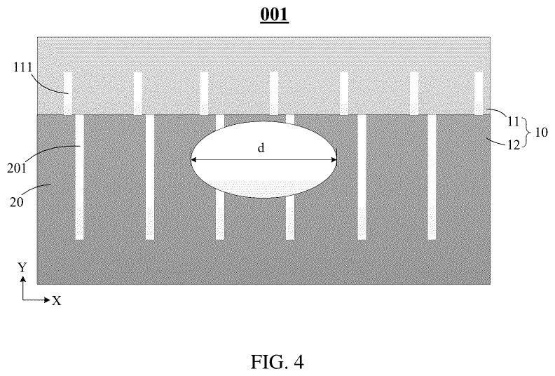

At an ambient temperature of 25° C., the lithium-ion battery is discharged at a current of 0.5 C until the voltage drops to 2.5 V, and then disassembled. A negative electrode plate is taken out, and is cleaned for 10 minutes by using dimethyl carbonate (DMC), so as to remove the electrolyte solution and the side reaction products on the surface. Subsequently, the negative electrode plate is placed in a 25° C. environment for 2 hours to obtain a dry negative electrode plate. An electrolyte solution is drawn in with a 5 mL medical syringe, and the air at the syringe head is expelled. The unwound dry negative electrode plate is placed on a horizontal tabletop such that the medical syringe is located directly above the negative electrode plate and perpendicular to the negative electrode plate. The vertical distance between the needle tip of the medical syringe and the negative electrode plate is 3 cm. 1 mL of electrolyte solution is dripped in vertically, and falls on the negative electrode plate. After 1 minute, the diffusion distance of the electrolyte solution is measured by using a flexible ruler with an accuracy of 0.2 mm. The distance between two points farthest apart to which the electrolyte solution is diffused on the negative electrode plate is measured. As shown in FIG. 4, the diffusion distance is the value of d in FIG. 4. The measurement is performed 5 times, and the average of the five measured values of d, denoted as d₁, is the diffusion distance of the electrolyte solution on the negative electrode plate. The electrolyte solution is the same as that in Embodiment 1-1. FIG. 4 is a schematic structural diagram of only a middle part of the electrode plate along the length direction (X direction) of the electrode plate unwound, and is merely illustrative.

The diffusion distance d₂ of the electrolyte solution on the positive electrode plate can be obtained in the same way except that the negative electrode plate is replaced with the positive electrode plate.

### Cycle Performance Test:

A lithium-ion battery in each embodiment and comparative embodiment is subjected to a charge-and-discharge cycle test in a 25° C. thermostat. The lithium-ion battery is charged at a constant current of 2 C until the voltage reaches 4.2 V, and then charged at a constant voltage of 4.2 V until the current tapers off to 0.05 C. The battery is left to stand for 5 minutes, and then discharged at a constant current of 6 C until the voltage drops to 2.5 V, thereby completing a first cycle. The discharge capacity at this time is recorded as a first-cycle discharge capacity C₁. The above charging and discharging operations are repeated for 600 cycles, and the discharge capacity of the lithium-ion battery is recorded as C₆₀₀. The cycle capacity retention rate at the end of the 600th cycle is calculated as a metric for evaluating the infiltration effect of the electrolyte solution on the positive electrode plate and the negative electrode plate and for evaluating the cycle performance of the lithium-ion battery. The calculation formula is shown in Formula (I). A lower 600^{th}-cycle capacity retention rate indicates a worse infiltration effect of the electrolyte solution in the lithium-ion battery on the electrode plate and lower cycle performance of the lithium-ion battery. A higher 600^{th}-cycle capacity retention rate indicates a better infiltration effect of the electrolyte solution in the lithium-ion battery on the electrode plate and higher cycle performance of the lithium-ion battery.

$$60 {0}^{t h} - cycle capacity retention rate ( \% ) = {C}_{600} / {C}_{1} \times 100 \% . \qquad ( I )$$

### Embodiment 1-1

### <Preparing a Negative Electrode Plate>

The electrode plate is a negative electrode plate. Artificial graphite as a negative active material, sodium carboxymethyl cellulose (CMC-Na), and styrene-butadiene rubber (SBR) are mixed at a mass ratio of 97:1.7:1.3, and then deionized water is added as a solvent. The mixture is stirred well to obtain a negative electrode slurry in which the solid content is 50 wt %. The negative electrode slurry is applied evenly onto one surface of a negative current collector copper foil that is 15 μm thick (T₀), and then dried at 105° C. to obtain a negative electrode plate coated with a negative electrode material layer on a single side. Subsequently, the above steps are repeated on the other surface of the negative current collector copper foil to obtain a negative electrode plate coated with the negative electrode material layer on both sides. The negative electrode plate is cold-pressed and slit, and then a coating region provided with the negative electrode material layer and a blank foil region of the negative current collector are delineated along the width direction of the negative electrode plate unwound. The coating weight of the negative electrode material layer is 107 mg/1540.25 mm², and the thickness H₀ of the negative electrode material layer is 80 μm.

A plurality of first stripes are disposed on the blank foil region on any one surface of the negative electrode plate, and second stripes are disposed on the negative electrode material layer. The maximum depth T₁ of the first stripes is set to 7.5 μm. T₁/T₀ is set to 0.5. Based on the width of the blank foil region, the length percentage W of a single first stripe is 45%. The width L of the first stripe is 0.6 mm. Along the length direction of the negative electrode plate unwound, the distance A between two adjacent first stripes is 5 mm. The mass M₀ of the blank foil region is 0.5068 g. The mass of a portion of the current collector equivalent to the plurality of first stripes in volume, that is, the etching amount M₁ of the blank foil region, is 0.0125 g. V is 0.0241. The maximum depth H₁ of the second stripes is set to 24 μm. H₁/H₀ is set to 0.3. Based on the width of the material layer, the length percentage W′ of a single second stripe is 45%. The width L′ of the second stripe is 0.4 mm. Along the length direction of the negative electrode plate unwound, the distance A′ between two adjacent second stripes is 5 mm. The mass M₀′ of the material layer is 6.8649 g. The mass of a portion of the material layer equivalent to a plurality of second stripes in volume, that is, the etching amount M₁′ of the material layer, is 0.0695 g. V′ is 0.0100. According to the above parameters, the first stripes and the second stripes are etched with a laser beam to obtain a negative electrode plate of 1610 mm×62 mm in size.

### <Preparing a Positive Electrode Plate>

Lithium nickel cobalt manganese oxide (LiNi_{0.8}Co_{0.1}Mn_{0.1}O₂) as a positive active material, polyvinylidene fluoride (PVDF) as a binder, and conductive carbon black are mixed at a mass ratio of 94.8:2.8:2.4 and dispersed in an N-methyl-pyrrolidone (NMP) solvent. The mixture is stirred well to obtain a positive electrode slurry in which the solid content is 72 wt %. One surface of a 15 μm-thick positive current collector aluminum foil is coated with the positive electrode slurry evenly, and dried at 105° C. to obtain a positive electrode plate coated with a positive electrode material layer on a single side. Subsequently, the above steps are repeated on the other surface of the positive current collector aluminum foil to obtain a positive electrode plate coated with the positive electrode material layer on both sides. Subsequently, the electrode plate is cold-pressed, cut, and slit, and dried in an 105° C. vacuum for 4 hours to obtain a positive electrode plate of 1600 mm×60 mm in size ready for use. The coating weight of the positive electrode material layer is 234 mg/1540.25 mm², and the compaction density of the positive electrode material layer is 3.4 g/cm³.

### <Separator>

A 12 μm-thick polyethylene (PP) film is used as a separator.

### <Preparing an Electrolyte Solution>

Ethylene carbonate (EC), ethyl methyl carbonate (EMC), and diethyl carbonate (DEC) are mixed at a mass ratio of 30:50:20 in an dry argon atmosphere glovebox to form an organic solvent, and then hexafluorophosphate (LiPF₆) is added as a lithium salt into the base solvent, and stirred well to obtain an electrolyte solution. Based on the mass of the electrolyte solution, the mass percent of LiPF₆ is 12.5%, and the remainder is the base solvent.

### <Preparing a Lithium-Ion Battery>

The above-prepared separator, positive electrode plate, separator, and negative electrode plate are stacked in sequence such that the separator is located between the positive electrode plate and the negative electrode plate to serve a function of separation. The stacked structure is wound and flattened to form an electrode assembly, and then a current collecting disc is welded to the electrode assembly. The electrode assembly is housed and then marked with product information by inkjet printing, and then the housed electrode assembly is dried in a vacuum. An electrolyte solution is injected into the house, and the house is staked, left to stand in a high-temperature environment, and subjected to chemical formation and capacity grading to obtain a lithium-ion battery. The upper-limit voltage of the chemical formation is 3.6 V, the temperature of the chemical formation is 45° C., and the static standing time in the chemical formation is 2 hours.

### Embodiments 2 to 45

These embodiments are the same as Embodiment 1 except that the relevant preparation parameters are adjusted according to Table 1. When the thickness H₀ of the material layer changes, the coating weight is adjusted so that the value of H₀ complies with Table 1.

### Embodiment 46

This embodiment is the same as Embodiment 1 except that the positive electrode plate is prepared according to the following steps:

### <Preparing a Positive Electrode Plate>

The electrode plate is a positive electrode plate. Lithium nickel cobalt manganese oxide (LiNi_{0.8}Co_{0.1}Mn_{0.1}O₂) as a positive active material, polyvinylidene fluoride (PVDF) as a binder, and conductive carbon black are mixed at a mass ratio of 94.8:2.8:2.4 and dispersed in an N-methyl-pyrrolidone (NMP) solvent. The mixture is stirred well to obtain a positive electrode slurry in which the solid content is 72 wt %. One surface of a positive current collector aluminum foil with a thickness (T₀) of 15 μm is coated with the positive electrode slurry evenly, and dried at 105° C. to obtain a positive electrode plate coated with a positive electrode material layer on a single side. Subsequently, the above steps are repeated on the other surface of the positive current collector aluminum foil to obtain a positive electrode plate coated with the positive electrode material layer on both sides. Subsequently, the positive electrode plate is cold-pressed and slit, and then a coating region provided with the positive electrode material layer and a blank foil region of the positive current collector are delineated along the width direction of the positive electrode plate unwound. The coating weight of the positive electrode material layer is 234 mg/1540.25 mm², and the thickness H₀ of the positive electrode material layer is 120 μm.

A plurality of first stripes are disposed on the blank foil region on any one surface of the positive electrode plate, and second stripes are disposed on the positive electrode material layer. The maximum depth T₁ of the first stripes is set to 7.5 μm. T₁/T₀ is set to 0.5. Based on the width of the blank foil region, the length percentage W of a single first stripe is 45%. The width L of the first stripe is 0.6 mm. Along the length direction of the negative electrode plate unwound, the distance A between two adjacent first stripes is 5 mm. The mass M₀ of the blank foil region is 0.2482 g. The mass of a portion of the current collector equivalent to the plurality of first stripes in volume, that is, the etching amount M₁ of the blank foil region, is 0.0061 g. V is 0.0241. The maximum depth H₁ of the second stripes is set to 36 μm. H₁/H₀ is set to 0.3. Based on the width of the material layer, the length percentage W′ of a single second stripe is 45%. The width L′ of the second stripe is 0.4 mm. Along the length direction of the negative electrode plate unwound, the distance A′ between two adjacent second stripes is 5 mm. The mass M₀′ of the material layer is 14.4385 g. The mass of a portion of the material layer equivalent to a plurality of second stripes in volume, that is, the etching amount M₁′ of the material layer, is 0.1462 g. V′ is 0.0100. According to the above parameters, the first stripes and the second stripes are etched with a laser beam to obtain a positive electrode plate of 1600 mm×60 mm in size.

### Comparative Embodiment 1

This comparative embodiment is the same as Embodiment 1 except that neither the first stripes nor the second stripes are disposed in <Preparing a negative electrode plate>.

### Comparative Embodiment 2

This comparative embodiment is the same as Embodiment 1 except that no second stripes are disposed and only the first stripes are disposed in <Preparing a negative electrode plate>.

### Comparative Embodiment 3

This comparative embodiment is the same as Embodiment 1 except that no first stripes are disposed and only the second stripes are disposed in <Preparing a negative electrode plate>.

### Comparative Embodiments 4 to 5

These embodiments are the same as Embodiment 1 except that the relevant preparation parameters are adjusted according to Table 1.

Table 1 shows the preparation parameters and performance parameters of each embodiment and comparative embodiment.

TABLE 1

| | V′ | M₀′ (g) | M₁′ (g) | V | M₀ (g) | M₁ (g) | T₀ (μm) | T₁/T₀ | T₁ (μm) |
|---|---|---|---|---|---|---|---|---|---|
| Embodiment 1 | 0.0100 | 6.8649 | 0.0695 | 0.0241 | 0.5068 | 0.0125 | 15 | 0.5 | 7.5 |
| Embodiment 2 | 0.0100 | 6.8649 | 0.0695 | 0.0097 | 0.5143 | 0.0050 | 15 | 0.2 | 3 |
| Embodiment 3 | 0.0100 | 6.8649 | 0.0695 | 0.0193 | 0.5093 | 0.0100 | 15 | 0.4 | 6 |
| Embodiment 4 | 0.0100 | 6.8649 | 0.0695 | 0.0338 | 0.5018 | 0.0176 | 15 | 0.7 | 10.5 |
| Embodiment 5 | 0.0100 | 6.8649 | 0.0695 | 0.0435 | 0.4967 | 0.0226 | 15 | 0.9 | 13.5 |
| Embodiment 6 | 0.0100 | 6.8649 | 0.0695 | 0.0459 | 0.4955 | 0.0238 | 15 | 0.95 | 14.25 |
| Embodiment 7 | 0.0100 | 6.8649 | 0.0695 | 0.0097 | 0.5143 | 0.0050 | 4 | 0.2 | 0.8 |
| Embodiment 8 | 0.0100 | 6.8649 | 0.0695 | 0.0097 | 0.5143 | 0.0050 | 25 | 0.2 | 5 |
| Embodiment 9 | 0.0033 | 6.9112 | 0.0232 | 0.0241 | 0.5068 | 0.0125 | 15 | 0.5 | 7.5 |
| Embodiment 10 | 0.0067 | 6.8881 | 0.0464 | 0.0241 | 0.5068 | 0.0125 | 15 | 0.5 | 7.5 |
| Embodiment 11 | 0.0134 | 6.8417 | 0.0927 | 0.0241 | 0.5068 | 0.0125 | 15 | 0.5 | 7.5 |
| Embodiment 12 | 0.0167 | 6.8185 | 0.1159 | 0.0241 | 0.5068 | 0.0125 | 15 | 0.5 | 7.5 |
| Embodiment 13 | 0.0201 | 6.7953 | 0.1391 | 0.0241 | 0.5068 | 0.0125 | 15 | 0.5 | 7.5 |
| Embodiment 14 | 0.0100 | 6.8649 | 0.0695 | 0.0241 | 0.5068 | 0.0125 | 15 | 0.5 | 7.5 |
| Embodiment 15 | 0.0100 | 6.8649 | 0.0695 | 0.0241 | 0.5068 | 0.0125 | 15 | 0.5 | 7.5 |
| Embodiment 16 | 0.0100 | 6.8649 | 0.0695 | 0.0054 | 0.5165 | 0.0028 | 15 | 0.5 | 7.5 |
| Embodiment 17 | 0.0100 | 6.8649 | 0.0695 | 0.0161 | 0.5110 | 0.0084 | 15 | 0.5 | 7.5 |
| Embodiment 18 | 0.0100 | 6.8649 | 0.0695 | 0.0322 | 0.5026 | 0.0167 | 15 | 0.5 | 7.5 |
| Embodiment 19 | 0.0100 | 6.8649 | 0.0695 | 0.0429 | 0.4970 | 0.0223 | 15 | 0.5 | 7.5 |
| Embodiment 20 | 0.0100 | 6.8649 | 0.0695 | 0.0483 | 0.4942 | 0.0251 | 15 | 0.5 | 7.5 |
| Embodiment 21 | 0.0100 | 6.8649 | 0.0695 | 0.0087 | 0.5148 | 0.0045 | 15 | 0.5 | 7.5 |
| Embodiment 22 | 0.0100 | 6.8649 | 0.0695 | 0.0167 | 0.5106 | 0.0087 | 15 | 0.5 | 7.5 |
| Embodiment 23 | 0.0100 | 6.8649 | 0.0695 | 0.0311 | 0.5032 | 0.0161 | 15 | 0.5 | 7.5 |
| Embodiment 24 | 0.0100 | 6.8649 | 0.0695 | 0.0376 | 0.4998 | 0.0195 | 15 | 0.5 | 7.5 |
| Embodiment 25 | 0.0022 | 6.9190 | 0.0155 | 0.0241 | 0.5068 | 0.0125 | 15 | 0.5 | 7.5 |
| Embodiment 26 | 0.0067 | 6.8881 | 0.0464 | 0.0241 | 0.5068 | 0.0125 | 15 | 0.5 | 7.5 |
| Embodiment 27 | 0.0134 | 6.8417 | 0.0927 | 0.0241 | 0.5068 | 0.0125 | 15 | 0.5 | 7.5 |
| Embodiment 28 | 0.0178 | 6.8108 | 0.1236 | 0.0241 | 0.5068 | 0.0125 | 15 | 0.5 | 7.5 |
| Embodiment 29 | 0.0026 | 6.9160 | 0.0184 | 0.0241 | 0.5068 | 0.0125 | 15 | 0.5 | 7.5 |
| Embodiment 30 | 0.0052 | 6.8984 | 0.0361 | 0.0241 | 0.5068 | 0.0125 | 15 | 0.5 | 7.5 |
| Embodiment 31 | 0.0145 | 6.8339 | 0.1005 | 0.0241 | 0.5068 | 0.0125 | 15 | 0.5 | 7.5 |
| Embodiment 32 | 0.0226 | 6.7780 | 0.1564 | 0.0241 | 0.5068 | 0.0125 | 15 | 0.5 | 7.5 |
| Embodiment 33 | 0.0262 | 6.7530 | 0.1814 | 0.0241 | 0.5068 | 0.0125 | 15 | 0.5 | 7.5 |
| Embodiment 34 | 0.0100 | 6.8649 | 0.0695 | 0.0844 | 0.4755 | 0.0439 | 15 | 0.5 | 7.5 |
| Embodiment 35 | 0.0100 | 6.8649 | 0.0695 | 0.0376 | 0.4998 | 0.0195 | 15 | 0.5 | 7.5 |
| Embodiment 36 | 0.0100 | 6.8649 | 0.0695 | 0.0178 | 0.5101 | 0.0092 | 15 | 0.5 | 7.5 |
| Embodiment 37 | 0.0100 | 6.8649 | 0.0695 | 0.0127 | 0.5127 | 0.0066 | 15 | 0.5 | 7.5 |
| Embodiment 38 | 0.0600 | 6.5183 | 0.4161 | 0.0241 | 0.5068 | 0.0125 | 15 | 0.5 | 7.5 |
| Embodiment 39 | 0.0159 | 6.8242 | 0.1102 | 0.0241 | 0.5068 | 0.0125 | 15 | 0.5 | 7.5 |
| Embodiment 40 | 0.0073 | 6.8837 | 0.0507 | 0.0241 | 0.5068 | 0.0125 | 15 | 0.5 | 7.5 |
| Embodiment 41 | 0.0064 | 6.8898 | 0.0447 | 0.0241 | 0.5068 | 0.0125 | 15 | 0.5 | 7.5 |
| Embodiment 42 | 0.2668 | 5.0841 | 1.8503 | 0.36 | 0.3324 | 0.1870 | 15 | 0.9 | 13.5 |
| Embodiment 43 | 0.3335 | 4.6215 | 2.3129 | 0.45 | 0.2856 | 0.2337 | 15 | 0.9 | 13.5 |
| Embodiment 44 | 0.0001 | 6.9336 | 0.0009 | 0.0004 | 0.5191 | 0.0002 | 15 | 0.2 | 3 |
| Embodiment 45 | 0.0100 | 6.8649 | 0.0695 | 0.0011 | 0.5187 | 0.0006 | 15 | 0.2 | 3 |
| Embodiment 46 | 0.0100 | 14.4385 | 0.1462 | 0.0241 | 0.2482 | 0.0061 | 15 | 0.5 | 7.5 |
| Comparative | / | 6.9344 | / | / | 0.5193 | / | 15 | / | / |
| Embodiment 1 | | | | | | | | | |
| Comparative | / | 6.9344 | / | 0.0241 | 0.5068 | 0.0125 | 15 | 0.5 | 7.5 |
| Embodiment 2 | | | | | | | | | |
| Comparative | 0.0100 | 6.8649 | 0.0695 | / | 0.5193 | / | 15 | / | / |
| Embodiment 3 | | | | | | | | | |
| Comparative | 0.5603 | 3.0487 | 3.8857 | 0.6713 | 0.1707 | 0.3486 | 15 | 0.95 | 14.25 |
| Embodiment 4 | | | | | | | | | |
| Comparative | 1.0404 × 10⁻⁵ | 6.9343 | 7.2144 × 10⁻⁵ | 3.3230 × 10⁻⁵ | 0.5193 | 1.7257 × 10⁻⁵ | 15 | 0.1 | 1.5 |
| Embodiment 5 | | | | | | | | | |

| | H₀ | | H₁ | W | L | W′ | L′ | A | A′ | d₁ | d₂ | 600^{th}-cycle capacity |
|---|---|---|---|---|---|---|---|---|---|---|---|---|
| | (μm) | H₁/H₀ | (μm) | (%) | (mm) | (%) | (mm) | (mm) | (mm) | (mm) | (mm) | retention rate (%) |
| Embodiment 1 | 80 | 0.3 | 24 | 45 | 0.6 | 45 | 0.4 | 5 | 5 | 8.2 | 5.21 | 81.3 |
| Embodiment 2 | 80 | 0.3 | 24 | 45 | 0.6 | 45 | 0.4 | 5 | 5 | 7.5 | 5.2 | 79.4 |
| Embodiment 3 | 80 | 0.3 | 24 | 45 | 0.6 | 45 | 0.4 | 5 | 5 | 7.9 | 5.19 | 80.9 |
| Embodiment 4 | 80 | 0.3 | 24 | 45 | 0.6 | 45 | 0.4 | 5 | 5 | 8.3 | 5.20 | 81.5 |
| Embodiment 5 | 80 | 0.3 | 24 | 45 | 0.6 | 45 | 0.4 | 5 | 5 | 8.4 | 5.18 | 79.5 |
| Embodiment 6 | 80 | 0.3 | 24 | 45 | 0.6 | 45 | 0.4 | 5 | 5 | 8.5 | 5.20 | 78.9 |
| Embodiment 7 | 20 | 0.3 | 6 | 45 | 0.6 | 45 | 0.4 | 5 | 5 | 7.3 | 5.21 | 79.3 |
| Embodiment 8 | 140 | 0.3 | 42 | 45 | 0.6 | 45 | 0.4 | 5 | 5 | 7.2 | 5.2 | 79.4 |
| Embodiment 9 | 80 | 0.1 | 8 | 45 | 0.6 | 45 | 0.4 | 5 | 5 | 8 | 5.19 | 79.5 |
| Embodiment 10 | 80 | 0.2 | 16 | 45 | 0.6 | 45 | 0.4 | 5 | 5 | 8.1 | 5.20 | 81.1 |
| Embodiment 11 | 80 | 0.4 | 32 | 45 | 0.6 | 45 | 0.4 | 5 | 5 | 8.3 | 5.18 | 81.8 |
| Embodiment 12 | 80 | 0.5 | 40 | 45 | 0.6 | 45 | 0.4 | 5 | 5 | 8.4 | 5.20 | 80.1 |
| Embodiment 13 | 80 | 0.6 | 48 | 45 | 0.6 | 45 | 0.4 | 5 | 5 | 8.5 | 5.21 | 79.2 |
| Embodiment 14 | 20 | 0.3 | 6 | 45 | 0.6 | 45 | 0.4 | 5 | 5 | 8 | 5.2 | 81 |
| Embodiment 15 | 140 | 0.3 | 42 | 45 | 0.6 | 45 | 0.4 | 5 | 5 | 7.4 | 5.19 | 80.5 |
| Embodiment 16 | 80 | 0.3 | 24 | 10 | 0.6 | 45 | 0.4 | 5 | 5 | 7.7 | 5.20 | 80.2 |
| Embodiment 17 | 80 | 0.3 | 24 | 30 | 0.6 | 45 | 0.4 | 5 | 5 | 8 | 5.18 | 81.1 |
| Embodiment 18 | 80 | 0.3 | 24 | 60 | 0.6 | 45 | 0.4 | 5 | 5 | 8.3 | 5.20 | 81.5 |
| Embodiment 19 | 80 | 0.3 | 24 | 80 | 0.6 | 45 | 0.4 | 5 | 5 | 8.5 | 5.21 | 80.1 |
| Embodiment 20 | 80 | 0.3 | 24 | 90 | 0.6 | 45 | 0.4 | 5 | 5 | 8.7 | 5.2 | 79.3 |
| Embodiment 21 | 80 | 0.3 | 24 | 45 | 0.2 | 45 | 0.4 | 5 | 5 | 7.7 | 5.19 | 79.1 |
| Embodiment 22 | 80 | 0.3 | 24 | 45 | 0.4 | 45 | 0.4 | 5 | 5 | 8.1 | 5.20 | 81.2 |
| Embodiment 23 | 80 | 0.3 | 24 | 45 | 0.8 | 45 | 0.4 | 5 | 5 | 8.3 | 5.18 | 81.6 |
| Embodiment 24 | 80 | 0.3 | 24 | 45 | 1 | 45 | 0.4 | 5 | 5 | 8.5 | 5.20 | 80.2 |
| Embodiment 25 | 80 | 0.3 | 24 | 45 | 0.6 | 10 | 0.4 | 5 | 5 | 7.8 | 5.21 | 80.3 |
| Embodiment 26 | 80 | 0.3 | 24 | 45 | 0.6 | 30 | 0.4 | 5 | 5 | 8.1 | 5.2 | 81.1 |
| Embodiment 27 | 80 | 0.3 | 24 | 45 | 0.6 | 60 | 0.4 | 5 | 5 | 8.3 | 5.19 | 81.5 |
| Embodiment 28 | 80 | 0.3 | 24 | 45 | 0.6 | 80 | 0.4 | 5 | 5 | 8.5 | 5.20 | 79.9 |
| Embodiment 29 | 80 | 0.3 | 24 | 45 | 0.6 | 45 | 0.1 | 5 | 5 | 7.8 | 5.18 | 80.1 |
| Embodiment 30 | 80 | 0.3 | 24 | 45 | 0.6 | 45 | 0.2 | 5 | 5 | 8.0 | 5.20 | 80.8 |
| Embodiment 31 | 80 | 0.3 | 24 | 45 | 0.6 | 45 | 0.6 | 5 | 5 | 8.3 | 5.21 | 81.9 |
| Embodiment 32 | 80 | 0.3 | 24 | 45 | 0.6 | 45 | 1 | 5 | 5 | 8.5 | 5.2 | 80.4 |
| Embodiment 33 | 80 | 0.3 | 24 | 45 | 0.6 | 45 | 1.2 | 5 | 5 | 8.6 | 5.19 | 79.2 |
| Embodiment 34 | 80 | 0.3 | 24 | 45 | 0.6 | 45 | 0.4 | 1 | 5 | 8.7 | 5.20 | 80.1 |
| Embodiment 35 | 80 | 0.3 | 24 | 45 | 0.6 | 45 | 0.4 | 3 | 5 | 8.5 | 5.18 | 81.9 |
| Embodiment 36 | 80 | 0.3 | 24 | 45 | 0.6 | 45 | 0.4 | 7 | 5 | 8 | 5.20 | 80.9 |
| Embodiment 37 | 80 | 0.3 | 24 | 45 | 0.6 | 45 | 0.4 | 10 | 5 | 7.9 | 5.21 | 79.8 |
| Embodiment 38 | 80 | 0.3 | 24 | 45 | 0.6 | 45 | 0.4 | 5 | 0.5 | 8.4 | 5.2 | 79.3 |
| Embodiment 39 | 80 | 0.3 | 24 | 45 | 0.6 | 45 | 0.4 | 5 | 3 | 8.3 | 5.19 | 81.5 |
| Embodiment 40 | 80 | 0.3 | 24 | 45 | 0.6 | 45 | 0.4 | 5 | 7 | 7.9 | 5.20 | 81.1 |
| Embodiment 41 | 80 | 0.3 | 24 | 45 | 0.6 | 45 | 0.4 | 5 | 8 | 7.6 | 5.18 | 80.2 |
| Embodiment 42 | 80 | 0.5 | 40 | 80 | 1 | 80 | 1 | 1 | 0.5 | 9.2 | 5.20 | 81.2 |
| Embodiment 43 | 80 | 0.5 | 40 | 100 | 1 | 100 | 1 | 1 | 0.5 | 9.4 | 5.21 | 75.2 |
| Embodiment 44 | 80 | 0.1 | 8 | 10 | 0.2 | 10 | 0.1 | 10 | 8 | 4.1 | 5.2 | 77.1 |
| Embodiment 45 | 80 | 0.3 | 24 | 10 | 0.6 | 45 | 0.4 | 10 | 5 | 7.3 | 5.0 | 78.5 |
| Embodiment 46 | 120 | 0.3 | 36 | 45 | 0.6 | 45 | 0.4 | 5 | 5 | 8.2 | 7.2 | 84.1 |
| Comparative | 80 | / | / | / | / | / | / | / | / | 3.6 | 5.20 | 72.7 |
| Embodiment 1 | | | | | | | | | | | | |
| Comparative | 80 | / | / | 45 | 0.6 | / | / | 5 | / | 4.2 | 5.20 | 73.4 |
| Embodiment 2 | | | | | | | | | | | | |
| Comparative | 80 | 0.3 | 24 | / | / | 45 | 0.4 | / | 5 | 4.6 | 5.21 | 73.9 |
| Embodiment 3 | | | | | | | | | | | | |
| Comparative | 80 | 0.7 | 56 | 100 | 1.2 | 100 | 1.2 | 0.5 | 0.3 | 9.6 | 5.2 | 70.2 |
| Embodiment 4 | | | | | | | | | | | | |
| Comparative | 80 | 0.05 | 4 | 5 | 0.1 | 5 | 0.05 | 15 | 12 | 3.9 | 5.19 | 73.2 |
| Embodiment 5 | | | | | | | | | | | | |

Note:
“/” in Table 1 represents absence of the relevant preparation parameter.

As can be seen from Embodiments 1 to 46 and Comparative Embodiments 1 to 5, by disposing the first stripes in the blank foil region and disposing the second stripes in the material layer, and by adjusting the values of V and V′ to fall within the range specified herein, this application increases the length of infiltration for the electrode plate, and improves the 600^{th}-cycle capacity retention rate of the lithium-ion battery. It indicates that the electrolyte solution produces a good infiltration effect on the electrode plate, and the lithium-ion battery exhibits good cycle performance. In Comparative Embodiment 1, the positive electrode plate and the negative electrode plate are not provided with the first stripes or the second stripes. In Comparative Embodiment 2, the negative electrode plate is provided with only the first stripes. In Comparative Embodiment 3, the negative electrode plate is provided with only the second stripes. In Comparative Embodiments 4 to 5, the values of V and V′ fall outside the ranges specified herein. In Comparative Embodiments 1 to 3 and Comparative Embodiment 4, the length of infiltration for the electrode plate is relatively short, and the 600^{th}-cycle capacity retention rate of the resultant lithium-ion battery is relatively low. In Comparative Embodiment 4, the values of V and V′ are excessively large, and are higher than the upper limit specified herein. Consequently, the loss of the content of the active material in the material layer is excessive, resulting in a decrease in the energy density of the lithium-ion battery. In addition, this increases the risk of lithium plating at the beginning of and in the late stage of cycling of the lithium-ion battery. Consequently, the 600^{th}-cycle capacity retention rate of the lithium-ion battery is decreased, and the cycle performance of the lithium-ion battery is inferior. In Embodiments 1 to 46, the length of infiltration for the electrode plate is relatively large, and the 600^{th}-cycle capacity retention rate of the resultant lithium-ion battery is higher. It indicates that the electrolyte solution produces a better infiltration effect on the electrode plate, and the lithium-ion battery exhibits higher cycle performance.

The values of T₁/T₀ and T₀ typically affect the cycle performance of the lithium-ion battery. As can be seen from Embodiments 1 to 8, when the values of T₁/T₀ and T₀ fall within the ranges specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance. The value of T₁/T₀ in Embodiment 6 is relatively large, and the length of infiltration for the electrode plate is relatively large. However, in practical production, when the ratio of the maximum depth of a single first stripe to the thickness of the current collector is excessively high, the difficulty of a fine-processing operation also increases, the current collector is prone to wrinkle during the processing, and the current collector is prone to slight fracture in actual use. The possibility of micro-short-circuits, lithium plating, and other phenomena inside the lithium-ion battery increases, so that the improvement in the 600^{th}-cycle capacity retention rate of the lithium-ion battery is relatively weak.

The values of H₁/H₀ and H₀ typically affect the cycle performance of the lithium-ion battery. As can be seen from Embodiment 1 and Embodiments 9 to 15, when the values of H₁/H₀ and H₀ fall within the ranges specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance. The value of H₁/H₀ in Embodiment 13 is relatively large, and the length of infiltration for the electrode plate is relatively large. However, when the ratio of the maximum depth of a single second stripe to the thickness of the material layer is excessively high, the content of the active material in the material layer is decreased, and the energy density of the lithium-ion battery is decreased. During cycling, the risk of lithium plating of the lithium-ion battery is relatively high, so that the improvement in the 600^{th}-cycle capacity retention rate of the lithium-ion battery is relatively weak.

The values of W and L typically affect the cycle performance of the lithium-ion battery. As can be seen from Embodiment 1 and Embodiments 16 to 24, when the values of W and L fall within the ranges specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance. The value of W in Embodiment 20 is relatively large, and the length of infiltration for the electrode plate is relatively large. However, when the length percentage of a single first stripe based on the width of the blank foil region is excessively high, the current collector is prone to wrinkle during the processing, and the current collector is prone to slight fracture in actual use. The possibility of micro-short-circuits, lithium plating, and other phenomena inside the lithium-ion battery increases, so that the improvement in the 600^{th}-cycle capacity retention rate of the lithium-ion battery is relatively weak.

The values of W′ and L′ typically affect the cycle performance of the lithium-ion battery. As can be seen from Embodiment 1 and Embodiments 25 to 33, when the values of W′ and L′ fall within the ranges specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance. The value of L′ in Embodiment 33 is relatively large, and the length of infiltration for the electrode plate is relatively large. However, when the width of a single second stripe is excessively large, the content of the active material in the material layer is decreased, and the energy density of the lithium-ion battery is decreased. In addition, the stored amount of the electrolyte solution is excessively large, and side reactions increase, thereby increasing the impedance of the lithium-ion battery. Consequently, the improvement in the 600^{th}-cycle capacity retention rate of the lithium-ion battery is slightly weak.

The value of A typically affects the cycle performance of the lithium-ion battery. As can be seen from Embodiment 1 and Embodiments 34 to 37, when the value of A falls within the range specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance.

The value of A′ typically affects the cycle performance of the lithium-ion battery. As can be seen from Embodiment 1 and Embodiments 38 to 41, when the value of A′ falls within the range specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance.

Along the length direction of the electrode plate unwound, the arrangement manner of the first stripes and the second stripes typically affects the cycle performance of the lithium-ion battery. As can be seen from Embodiment 1 and Embodiment 43, when the arrangement manner of the first stripes and the second stripes along the length direction of the electrode plate unwound falls within the range specified herein, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance.

The electrode plate being a positive electrode plate and/or a negative electrode plate typically affects the cycle performance of the lithium-ion battery. As can be seen from Embodiment 1 and Embodiment 46, when the electrode plate is a positive electrode plate and/or a negative electrode plate, the length of infiltration for the electrode plate is relatively large, and the 600^{th}-cycle capacity retention rate of the lithium-ion battery is relatively high. It indicates that the electrolyte solutions in these embodiments of this application produce a good infiltration effect on the electrode plate, and the lithium-ion battery exhibits good cycle performance.

It is hereby noted that the relational terms herein such as “first” and “second” are used merely to differentiate one entity or operation from another, but do not involve or imply any actual relationship or sequence between the entities or operations. Moreover, the terms “include”, “comprise”, and any variation thereof are intended to cover a non-exclusive inclusion relationship by which a process, method, or object that includes or comprises a series of elements not only includes such elements, but also includes other elements not expressly specified or also includes inherent elements of the process, method, or object.

Different embodiments of this application are described in a correlative manner. For the same or similar part in one embodiment, reference may be made to another embodiment. Each embodiment focuses on differences from other embodiments.

Described above are merely preferred embodiments of this application that are not intended to limit this application. Any modifications, equivalent replacements, improvements, and the like made without departing from the concept and principles of this application still fall within the protection scope of this application.

What is claimed is:

1. A columnar secondary battery, comprising an electrode plate, wherein the electrode plate comprises a current collector and a material layer located on at least one surface of the current collector; along a width direction of the electrode plate, the current collector comprises a coating region coated with the material layer, and a blank foil region, and at least a part of the blank foil region forms a flattened portion;
the blank foil region is provided with a plurality of first stripes, the plurality of first stripes extend along the width direction and are spaced apart from each other along a length direction of the electrode plate, a mass of the blank foil region is M₀ g, a mass of a portion of the current collector equivalent to the plurality of first stripes in volume is M₁ g, and V=M₁/(M₀+M₁); and
the material layer is provided with a plurality of second stripes, the plurality of second stripes extend along the width direction and are spaced apart from each other along the length direction, a mass of the material layer is M₀′ g, a mass of a portion of the material layer equivalent to the plurality of second stripes in volume is M₁′ g, and V′=M₁′/(M₀′+M₁′), 0.1 V′≤V≤0.45, and 0.0001≤V′≤0.35.

2. The columnar secondary battery according to claim 1, wherein, along the width direction of the electrode plate, at least one of the plurality of first stripes extends through an end surface of the blank foil region at one end of the blank foil region facing away from the material layer; and/or, along the width direction of the electrode plate unwound, at least one of the plurality of second stripes extends through at least one end surface of the material layer.

3. The columnar secondary battery according to claim 1, wherein 0.1 V′≤V≤0.36; and/or 0.002≤V′≤0.27.

4. The columnar secondary battery according to claim 1, wherein, along a thickness direction of the electrode plate, a thickness of the current collector is T₀ μm, and a maximum depth of a single first stripe is T₁ μm, 0.2≤T₁/T₀≤0.9, and 4≤T₀≤25.

5. The columnar secondary battery according to claim 4, wherein 0.4≤T₁/T₀≤0.7.

6. The columnar secondary battery according to claim 1, wherein, along a thickness direction of the electrode plate, a thickness of the material layer is H₀ μm, and a maximum depth of a single second stripe is H₁ μm, 0.1≤H₁/H₀≤0.5, and 20≤H₀≤140.

7. The columnar secondary battery according to claim 6, wherein 0.2≤H₁/H₀≤0.4.

8. The columnar secondary battery according to claim 1, wherein, along the length direction of the electrode plate, a distance between two adjacent first stripes is A mm, 1≤A≤10.

9. The columnar secondary battery according to claim 8, wherein 3≤A≤7.

10. The columnar secondary battery according to claim 1, wherein, along the length direction of the electrode plate, a distance between two adjacent second stripes is A′ mm, 0.5≤ A′≤8.

11. The columnar secondary battery according to claim 10, wherein 3≤A′≤7.

12. The columnar secondary battery according to claim 1, wherein, along the width direction of the electrode plate, based on a width of the blank foil region, a length percentage of a single first stripe is W, 10%≤W≤80%; and, along the length direction of the electrode plate, a width of a single first stripe is L mm, 0.2≤L≤1.

13. The columnar secondary battery according to claim 12, wherein 30%≤W≤60%, and 0.4≤L≤0.8.

14. The columnar secondary battery according to claim 1, wherein, along the width direction of the electrode plate, based on a width of the material layer, a length percentage of a single second stripe is W′, 10%≤W′≤80%; and, along the length direction of the electrode plate, a width of a single second stripe is L′ mm, 0.1≤L′≤1.

15. The columnar secondary battery according to claim 14, wherein 30%≤W′≤60%, and 0.2≤L′≤0.6.

16. The columnar secondary battery according to claim 1, wherein the electrode plate is a negative electrode plate.

17. An electronic device, comprising a columnar secondary battery, the columnar secondary battery comprising an electrode plate, wherein the electrode plate comprises a current collector and a material layer located on at least one surface of the current collector; along a width direction of the electrode plate, the current collector comprises a coating region coated with the material layer, and a blank foil region, and at least a part of the blank foil region forms a flattened portion;
the blank foil region is provided with a plurality of first stripes, the plurality of first stripes extend along the width direction and are spaced apart from each other along a length direction of the electrode plate, a mass of the blank foil region is M₀ g, a mass portion of the current collector equivalent to the plurality of first stripes in volume is M₁ g, and V=M₁/(M₀+M₁); and
the material layer is provided with a plurality of second stripes, the plurality of second stripes extend along the width direction and are spaced apart from each other along the length direction, a mass of the material layer is M₀′ g, a mass of a portion of the material layer equivalent to the plurality of second stripes in volume is M₁′ g, and V′=M₁′/(M₀′+M₁′), 0.1 V′≤V≤0.45, and 0.0001≤V′≤0.35.

18. The electronic device according to claim 17, wherein, along the width direction of the electrode plate, at least one of the plurality of first stripes extends through an end surface of the blank foil region at one end of the blank foil region facing away from the material layer; and/or, along the width direction of the electrode plate, at least one of the plurality of second stripes extends through at least one end surface of the material layer.

19. The electronic device according to claim 17, wherein, along a thickness direction of the electrode plate, a thickness of the current collector is T₀ μm, and a maximum depth of a single first stripe is T₁ μm, 0.2≤T₁/T₀≤0.9, and 4≤T₀≤25.

20. The electronic device according to claim 17, wherein, along a thickness direction of the electrode plate, a thickness of the material layer is H₀ μm, and a maximum depth of a single second stripe is H₁ μm, 0.1≤H₁/H₀≤0.5, and 20≤H₀≤140.
